(19) United States
(12) Patent Application Publication
(10) Pub. No.: US 2014/0189596 A1
(43) Pub. Date: Jul. 3, 2014

(54) INFORMATION PROCESSING APPARATUS, SCREEN CONTROL PROGRAM AND SCREEN CONTROL METHOD

(71) Applicant: Kabushiki Kaisha Toshiba, Tokyo (JP)

(72) Inventor: Kenichi Taniuchi, Yokohama-shi (JP)

(73) Assignee: KABUSHIKI KAISHA TOSHIBA, Tokyo (JP)

(21) Appl. No.: 14/013,831

(22) Filed: Aug. 29, 2013

Related U.S. Application Data
(63) Continuation of application No. PCT/JP2013/058495, filed on Mar. 25, 2013.

(30) Foreign Application Priority Data
Dec. 27, 2012 (JP) 2012-285459

(51) Int. Cl. G06F 3/0481; G06F 3/0482

(52) U.S. Cl. CPC G06F 3/04817; G06F 3/0482
USPC 715/835

(57) ABSTRACT

According to one embodiment, an information processing apparatus includes first and second display controllers. The first display controller outputs a first screen including an icon to be selected based on whether a program corresponding to the icon is updated, and outputs the first screen when the apparatus is reactivated from a standby mode, the first screen including first and second icons which correspond to first and second programs. The second display controller outputs a second screen including the first icon and changeable from the first screen and outputs a third screen including the second icon and changeable from the second screen.

### CROSS REFERENCE TO RELATED APPLICATIONS

This application is a Continuation Application of PCT Application No. PCT/JP2013/058495, filed Mar. 25, 2013 and based upon and claiming the benefit of priority from Japanese Patent Application No. 2012-285459, filed Dec. 27, 2012, the entire contents of all of which are incorporated herein by reference.

### FIELD

Embodiments described herein relate generally to an information processing apparatus, screen control program, and screen control method.

### BACKGROUND

In a launcher program executed in a device such as a tablet, smart phone, or the like, a start screen is displayed when the device is booted, and the start screen includes icons to launch various applications. The various applications are, for example, mailer, browser application, and music player application, and the like. When an icon is selected in the screen, an application corresponding to the icon is launched. In such a launcher, when the number of the installed applications or the number of icons of the applications arranged by a user is increased, the increased icons do not remain in a single screen and the overflowing icons will be arranged on the other screen changeable from the single screen.

Here, when the application information is updated, for example, when the mailer receives a mail, the update should preferably be informed to the user in an easily understandable manner.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating an example of an information processing apparatus of the present embodiment.

FIG. 2 is a perspective view illustrating another example of the information processing apparatus of the present embodiment.

FIG. 3 is a block diagram of an example of a system configuration of the information processing apparatus of the present embodiment.

FIG. 4 is a diagram of an example of processing blocks in an UI control program of the information processing apparatus of the present embodiment.

FIG. 5A illustrates an example of a lock screen displayed by the information processing apparatus of the present embodiment.

FIG. 5B illustrates an example of a login screen displayed by the information processing apparatus of the present embodiment.

FIG. 5C illustrates another example of the login screen displayed by the information processing apparatus of the present embodiment.

FIG. 6A illustrates an example of an update notification screen displayed by the information processing apparatus of the present embodiment.

FIG. 6B illustrates another example of the update notification screen displayed by the information processing apparatus of the present embodiment.

FIG. 6C illustrates an example of an update notification icon displayed by the information processing apparatus of the present embodiment.

FIG. 6D illustrates another example of the update notification icon displayed by the information processing apparatus of the present embodiment.

FIG. 7A illustrates an example of a start screen displayed by the information processing apparatus of the present embodiment.

FIG. 7B illustrates another example of the start screen displayed by the information processing apparatus of the present embodiment.

FIG. 7C illustrates still another example of the start screen displayed by the information processing apparatus of the present embodiment.

FIG. 8A illustrates an example of a screen control flow in the information processing apparatus of the present embodiment.

FIG. 8B illustrates another example of the screen control flow in the information processing apparatus of the present embodiment.

### DETAILED DESCRIPTION

Hereinafter, the present embodiment is described with reference to the drawings.

In general, according to one embodiment, an information processing apparatus includes a first display controller and a second display controller. The information processing apparatus is configured to output a screen on a display module. The first display controller is configured to output a first screen including an icon to be selected based on whether a program corresponding to the icon is updated, the first display controller being configured to output the first screen when the information processing apparatus is reactivated from a standby mode, the first screen including first and second icons which correspond to first and second programs and include images related to the update. The second display controller is configured to output a second screen including the first icon and changeable from the first screen and to output a third screen including the second icon and changeable from the second screen. The first icon in the first screen and the first icon in the second screen are indicative of an identical update. The second icon in the first screen and the second icon in the third screen are indicative of an identical update.

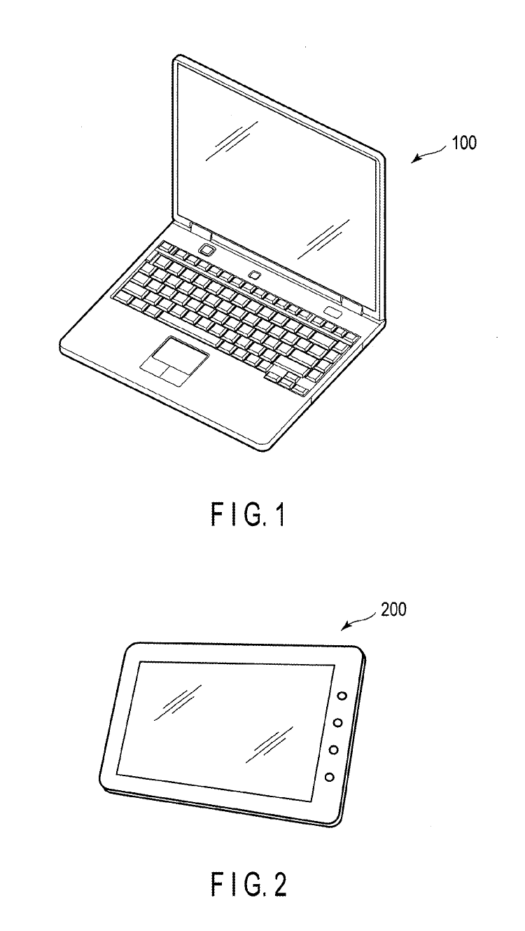

FIGS. 1 and 2 are perspective views illustrating examples of an information processing apparatus of the present embodiment. The information processing apparatus is realized as a notebook type PC 100 or a slate type tablet 200 which can be driven by a battery, for example.

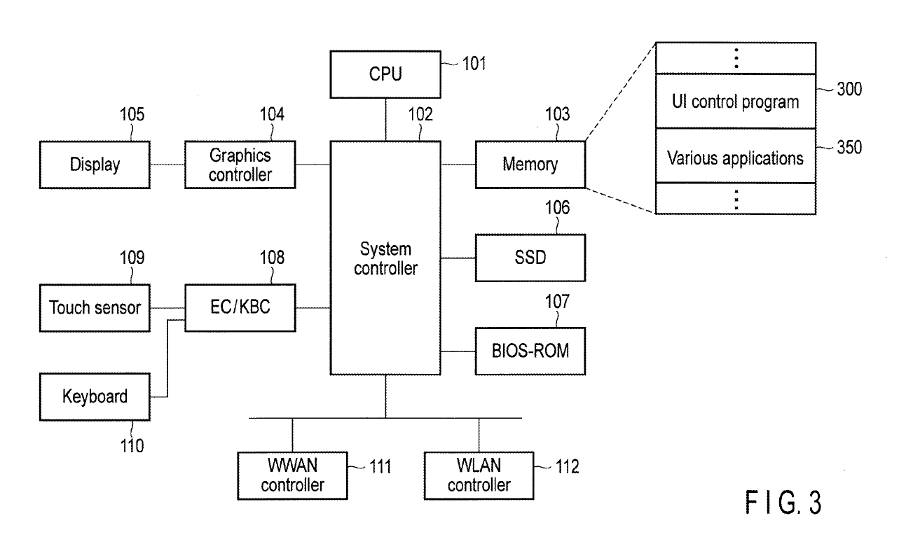

FIG. 3 illustrates an example of the system configuration of the PC 100. The system configuration of the tablet 200 is substantially the same as that of the PC 100. Thus, the configuration of the PC 100 is mainly described below.

The PC 100 includes a CPU 101, system controller 102, memory 103, graphics controller (GPU) 104, display 105, solid state drive (SSD) 106, BIOS-ROM 107, embedded controller/keyboard controller (EC/KBC) 108, touch sensor 109, keyboard 110, WWAN (Wireless Wide Area Network) controller 111, WLAN (Wireless Local Area Network) controller 112, and the like.

The CPU 101 is a processor which controls the operations of the respective components in the PC 100. The CPU 101 executes programs loaded from the SSD 106 into the memory 103, for example, an operating system (OS), UI control program 300, and various applications 350. Here, the various applications include, for example, a mail application, weather forecast application, photograph display application, net shop site display application, map display application, browser application, music player application, calendar application, game application, coupon acquisition application, phone application, SNS viewer application, and the like.

Furthermore, the CPU 101 executes BIOS (Basic Input Output System) stored in BIOS-ROM 107 which is a nonvolatile memory. The BIOS is a system program for controlling hardware.

The system controller 102 is a bridge device connecting between the CPU 101 and each component. The system controller 102 includes a serial ATA controller which controls the SSD 106. The system controller 102 has a function to execute the communication with the GPU 104 via a serial bus of PCI EXPRESS standard and the like.

The GPU 104 is a display controller for controlling the display 105 used as a display monitor of the PC 100. The GPU 104 generates a display signal to be supplied to the display 105 based on display data stored in a video memory which is not shown. A part of the memory 103 may be used as the aforementioned video memory.

The EC/KBC 108 is a single chip microcomputer in which an embedded controller (power management controller) which manages the power of the PC 100, a touch sensor controller which controls the touch sensor 109, and a key board controller which controls the keyboard 110 are integrated.

The touch sensor 109 is, for example, a touch panel provided in the display 105 or a touch pad provided in a palm rest of the PC 100, and detects a touch operation by a user on the touch panel/touch pad. In the present embodiment, the operation detection by the touch panel, which detects a touch operation on the display 105, is mainly described but a mouse or the like may be used as an input device.

The WWAN controller 111 is a communication module which controls, for example, mobile communication, and communicates with a mobile communication base station via an antenna which is not shown. The WLAN controller 112 communicates with a WLAN base station via an antenna which is not shown.

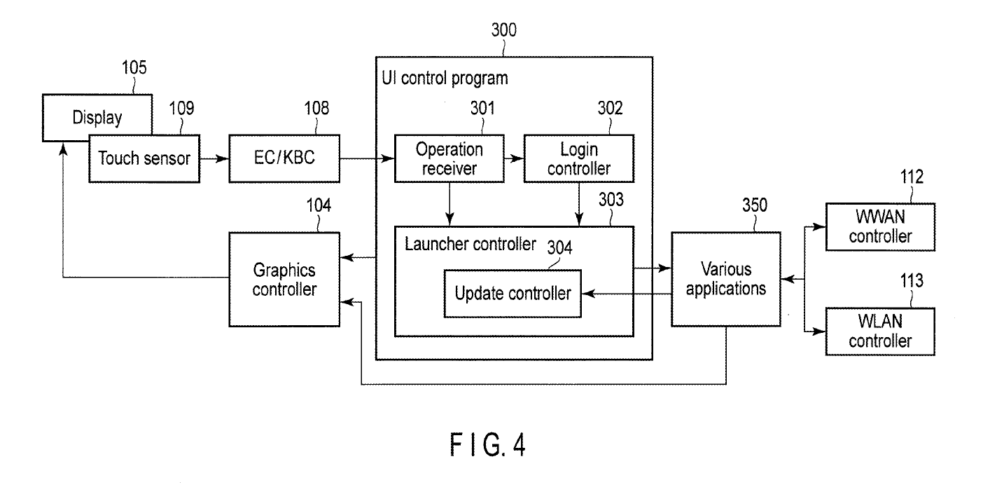

FIG. 4 illustrates an example of SW/HW processing block configuration related to the UI control program 300 of the PC 100. The UI control program 300 includes the operation receiver 301, login controller 302, and launcher controller 303. Here, the UI control program 300 may be run as a program included in an operating system.

Operation information is input in the operation receiver 301 from the EC/KBC 108. Here, the operation information is, for example, coordinate information of the touch operation detected by the touch sensor 109 and the like. The operation receiver 301 outputs the input operation information to the login controller 302 or launcher controller 303.

The login controller 302 controls a user login to the predetermined account of the operating system. When the PC 100 has returned from the standby mode to the active mode, specifically, for example, when the state of the PC 100 changes from the Connected Standby state to the S0 state of the ACPI standard, the login controller 302 displays a login screen for authenticating the user login. The Connected Standby stands for a display system in which the display 105 and the graphics controller 104 are in an off-state while the CPU 101, communications modules (the WWAN controller 111 and the WLAN controller 112, etc.) and the like are in operation. However, in a smart phone, this state may be referred to as a “standby mode” instead of the Connected Standby.

If valid authentication information such as a password and the predetermined gesture is input while the login screen is displayed, the login controller 302 permits login to the predetermined account. The login controller 302 may display a lock screen before displaying the login screen, and may display the login screen if the predetermined operation is input for the lock screen. Moreover, the login controller 302 may allow a user login without displaying the login screen if the predetermined operation is input for the lock screen.

The launcher controller 303 has a function of generating a start screen on which icons respectively corresponding to the various applications 350 are arranged and displaying the screen on the display 105. The launcher controller 303 includes the update controller 304 which executes a process related to an update notification icon for notifying update of the applications 350. The update controller 304 obtains update information related to the update of the application status of each application 350. Based on the update information, the update controller 304 selects an updated application, and generates an update notification screen including an update notification icon corresponding to the selected application. Thus, when generating the update notification screen, the update controller 304 does not select an application which has not been updated and does not arrange an icon corresponding to the unselected application on the update notification screen.

When the update notification screen including a plurality of update notification icons is generated, the update controller 304 may arrange update notification icons in accordance with, for example, the priority order for each application set by the user and the latest updated time for each application, etc. Further, the alignment of each icon on a start screen described below may be reflected. An icon located on the left side on the start screen may be arranged so as to be further left, and an icon located on the upper side may be arranged so as to be further up.

When the launcher controller 303 receives an operation for the icon on the displayed screen, the launcher controller 303 notifies the application corresponding to the icon of start via the OS. The update controller 304 may be an application program which is independent from the UI control program 300. In this case, the update controller 304 is resident at the time of operating the system, and operates to generate and display the update notification screen when the PC 100 is reactivated.

Each of the applications 350 generates a display screen itself and displays the screen on the display 105 when each application is started. When the PC 100 is in the active mode or in the Connected Standby state, the applications 350 operate in the background and update the application status.

The update of the application status is explained with examples. For example, a mailer communicates with a network server using a communication module. When the mailer receives a mail, the application status of the mailer is updated. As for a telephone application, when the telephone application receives a call, the application status of the telephone application is updated. As for an SNS browse application, when another user who was registered as a friend updates SNS information and then the SNS browse application receives the notification of the update, the application status of the SNS browse application is updated. As for a coupon acquisition application, when the coupon acquisition application receives coupon information of a store near the current location of the PC 100, the application status of the coupon acquisition application is updated. As for a calendar application, even if the calendar application receives no information from the outside, the application status of the calendar application is updated in order to execute an alert when the time or date of the set schedule has arrived or is approaching.

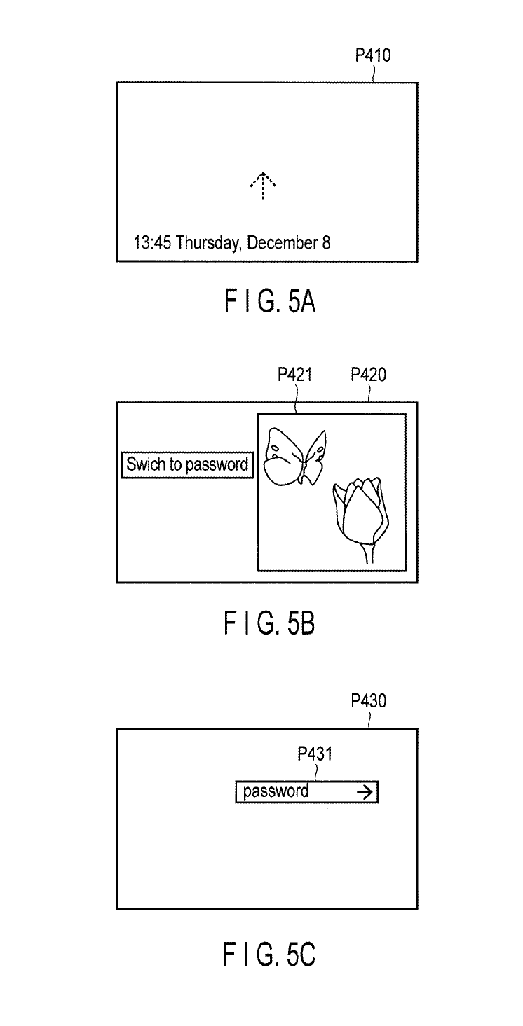

FIGS. 5A to 5C illustrate structural examples of the lock screen and the login screen which are generated by the login controller 302. FIG. 5A illustrates a structural example of the lock screen. In the lock screen, for example, the current time and date are displayed. If the predetermined operation is performed for the lock screen, the login controller 302 unlocks the screen lock and displays the next screen. The predetermined operation is, for example, a swipe operation in the specific direction on the touch sensor 109. The next screen may be a login screen, start screen, and the like.

FIGS. 5B and 5C illustrate structural examples of the login screen. In a screen P420 shown in FIG. 5B, an image P421 is displayed. If the login controller 302 receives an operation of selecting a preset area in the image P421, the login controller 302 determines that valid authentication information is input and approves the login. In a screen P430 shown in FIG. 5C, an image P431 is displayed. If a predetermined code is input after the image P431 is selected, the login controller 302 determines that the valid authentication information is input and approves the login. If the login is approved, the launcher controller 303 generates a launcher screen and displays it on the display 105.

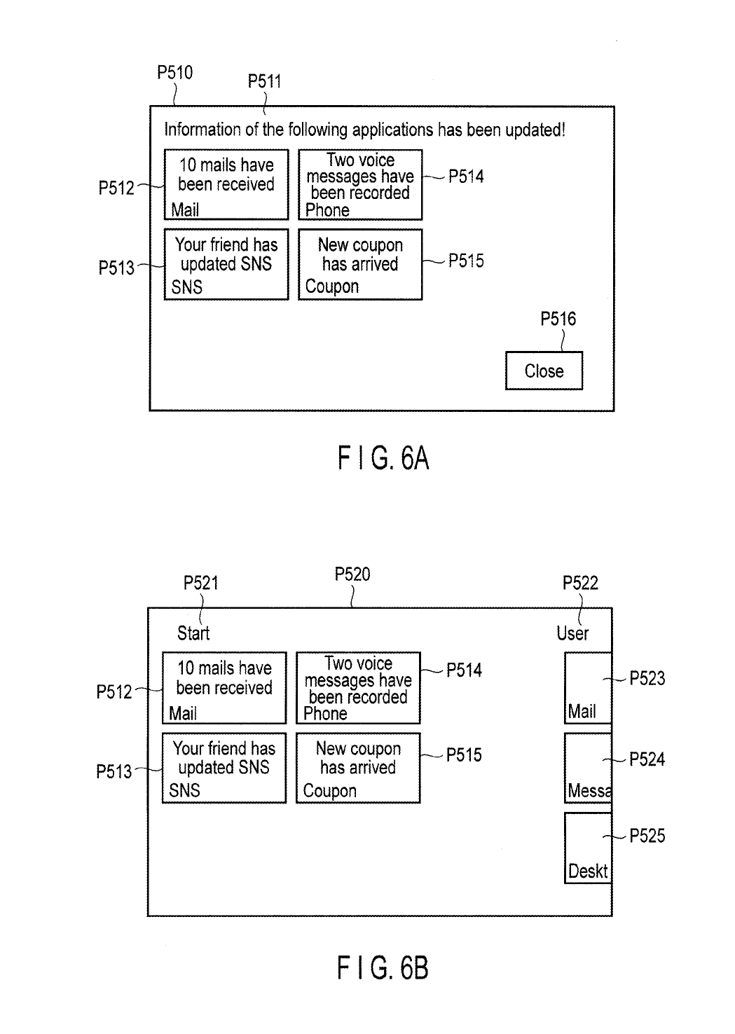

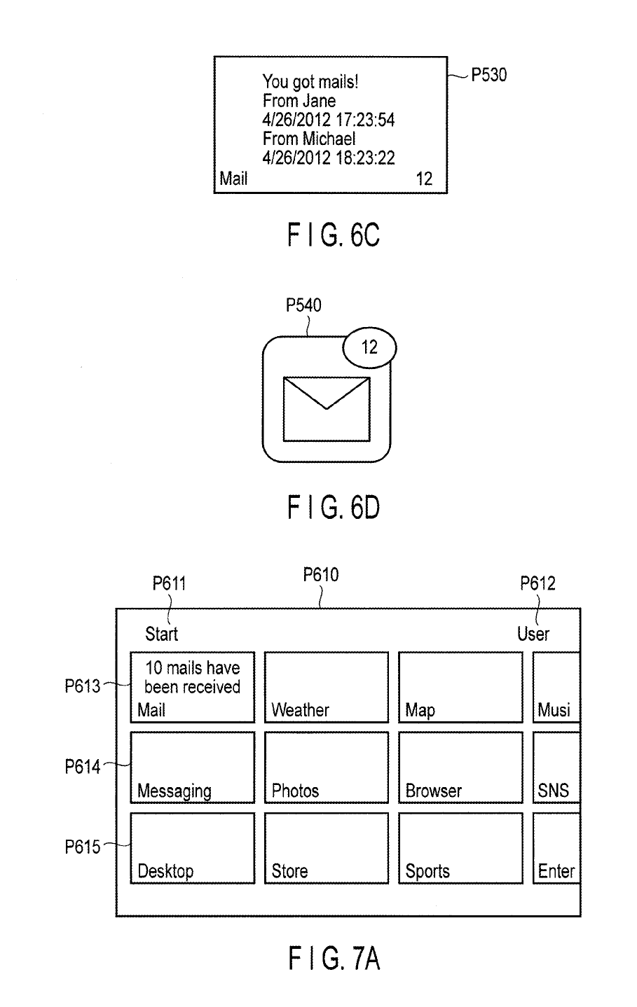

FIGS. 6A to 6D illustrate structural examples of the update notice screen generated by the update controller 304 of the launcher controller 303. Here, the update notice screen may be regarded as a kind of launcher screen. A notice P511, update notice icons P512 to P515, and button P516 are displayed on an update notice screen P510 shown in FIG. 6A. The notice P511 shows an image (text) indicating that an application is updated.

Each of the update notice icons P512 to P515 is an icon corresponding to the application whose status is updated. Each icon includes an image (text) indicating an application name and an image (text) indicating an updated content (notice information). That is, the icon P512 includes the application name “Mail” and the notice information of “10 mails have been received”. The icon P513 includes the application name “SNS” and the notice information of “Your friends have updated SNS”. The icon P514 includes the application name “Phone” and the notice information of “Two voice messages have been recorded”. The icon P515 includes the application name “Coupon” and the notice information of “New coupon has arrived”. The update notice icon has, for example, the shape of a rectangular tile. When a plurality of icons are arranged, these icons are arranged at regular intervals. If there is an input operation to one of the icons, an application corresponding to the operated icon is started, and transition to the screen of the application is performed.

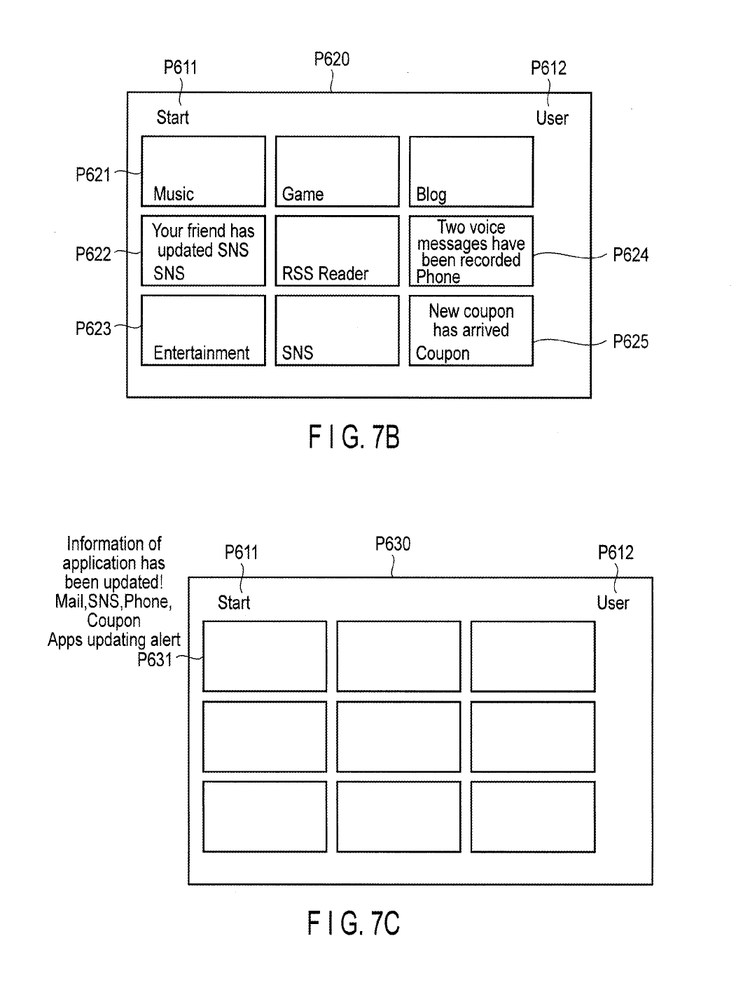

The button P516 is a software button to close the update notice screen. If an operation input to the button P516 is received, the display screen is changed to a default start screen shown in FIG. 7A.

In an update notice screen P520 of FIG. 6B, an image P521, an image P522, icons P523 to P525, and update notice icons P512 to P515 are displayed. The image P521 is an image indicating that the screen P520 is the start screen. That is, the update notice screen P520 is configured as a part of the start screen. The image P522 shows an account name of a logging-in user. The icons P523 to P525 correspond to the icons at the left end on the start screen shown in FIG. 7A. The update notice icons P512 to P515 are explained with respect to FIG. 6A. If an operation to change from the screen P520 to the right screen thereof (for example, a swipe operation in a left direction) is performed on the screen P520, the displayed screen is changed to the start screen of FIG. 7A.

FIG. 6C illustrates a display example of the update notice icon. The application name, an indication that a mail is received, a user name of a transmission source of the mail, a received date and time of the mail, and the number of received mails are displayed within the region of the image of the update notice icon P530. Various applications 350 determine and generate a content displayed in this update notice icon. That is, when the update notice screen is generated, the update controller 304 arranges the icon of the application whose status has been updated on the screen based on update information of the update of each of the applications 350, the update information obtained from the various applications 350. If the icon is arranged, the application corresponding to the icon generates an image and text regarding the notice information to be displayed in the icon. If the notice information to be displayed cannot be contained within the area of the icon, the application corresponding to the icon displays the notice information such that the notice information is automatically scrolled in the icon.

That is, in the example of FIG. 6C, the update controller 304 arranges the icon P530 corresponding to a mail application on the update notice screen. The mail application then displays the application name, the indication that the mail has been received, the user name of the transmission source of the mail, the received date and time of the mail, and the number of received mails in the icon P530. The update controller 304 may obtain, from each of the applications 350, respective notice information of each application and display the obtained respective notice information within the icon.

FIG. 6C is an example of a case where the update notice icon corresponds to the mail application. If the update notice icon corresponds to another application, other information is displayed in the icon. For example, if the application is a calendar, a remaining time to schedule start, a schedule start time, a schedule description, and the like are displayed in the update notice icon.

FIG. 6D illustrates another display example of the update notification icon. In the update notification icon P540, an image indicative of a kind of application (a mail application therein) and the number of received mails are displayed. In FIG. 6C, the entire information is displayed within the region of the image of the icon while, in FIG. 6D, the information is displayed partly out of the region of the image of the icon. In either case, the information is displayed on the icon. However, update information may be displayed at a position close to but completely out of the icon, for example.

FIGS. 7A to 7C illustrate screen structure examples of the start screen. In the start screen P610 shown in FIG. 7A, an image P611, image P612, and icons P613 to P615, and the like are displayed. FIG. 7B illustrates a start screen displayed in response to a leftward swipe operation on the start screen P610, and such icons as icons P621 to P625 are displayed therein. The image P611 indicates that the screen P610 is a start screen and the image P612 indicates a login user name.

The icons such as P613 to P615 and P621 to P625 are images to activate applications, and if an application status is updated, an image indicative of the contents of the update is displayed therein. That is, the icon P512 shown in FIGS. 6A and 6B and the icon P613 shown in FIG. 7A have the same notification information displayed in the respective icons, and also have the same icon exterior (icon image). Similarly, the same notification information is displayed in the icon P513 and icon P622, the same notification information is displayed in the icon P514 and icon P624, and the same notification information is displayed in the icon P515 and icon P625. The icon exterior is similarly the same in the respective cases.

Here, when the update controller 304 works as an independent application, an icon P631 which corresponds to the application of the update controller 304 may be displayed as shown in FIG. 7C. The icon P631 displays, for example, a report of application information update and a name of updated application, and the like. The icon P631 may be displayed in the screen P610 or P620.

In that case, the PC 100 displays the update notification screen as shown in FIG. 6A upon receipt of the selection operation to the icon P631. The update controller 304 may acquire the update information from the various applications 350 upon receipt of the operation to the icon P631, or may acquire the update information by polling the various applications 350 at certain intervals in advance to the operation to the icon P631.

When an application screen is displayed by selecting an icon on the update notification screen shown in FIGS. 6A and 6B, it is assumed that the notification information of the application has been confirmed. When the notification information has been confirmed, the image related to the update in the icon is not displayed. That is, once the update notification icon is selected in the update notification screen and the application update corresponding to the icon is confirmed, the notification information is not displayed in the icon corresponding to the update-confirmed application after the screen change to that is shown in FIG. 7A or 7B. On the other hand, when the update notification icon is not selected in the update notification screen and then the screen changes to that is shown in FIG. 7A or 7B, the icon of the application which has not been selected still displays the identical notification information as in the update notification icon.

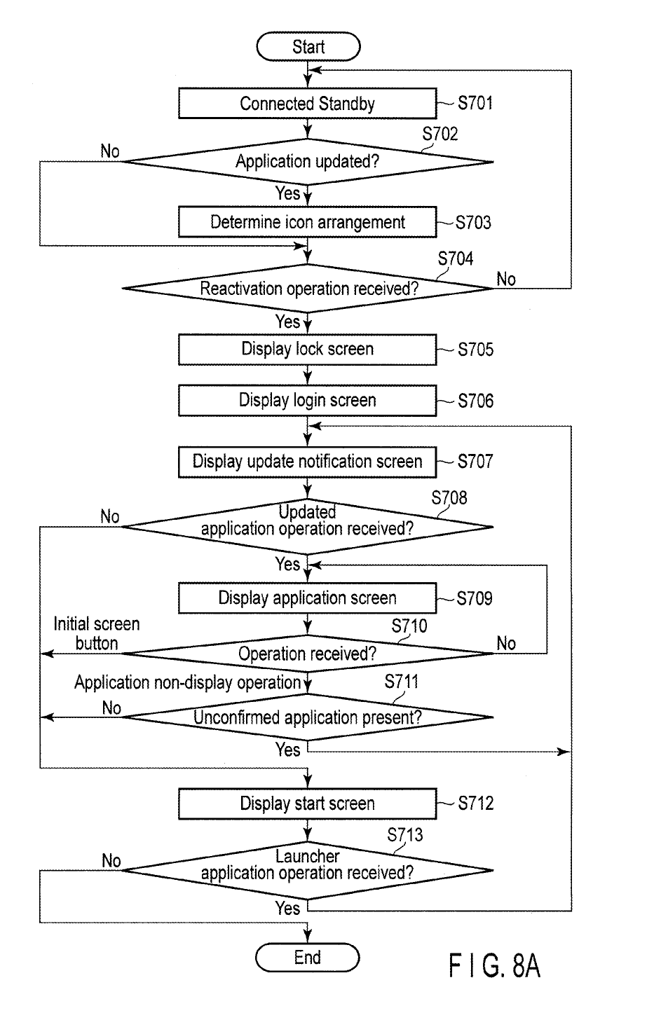

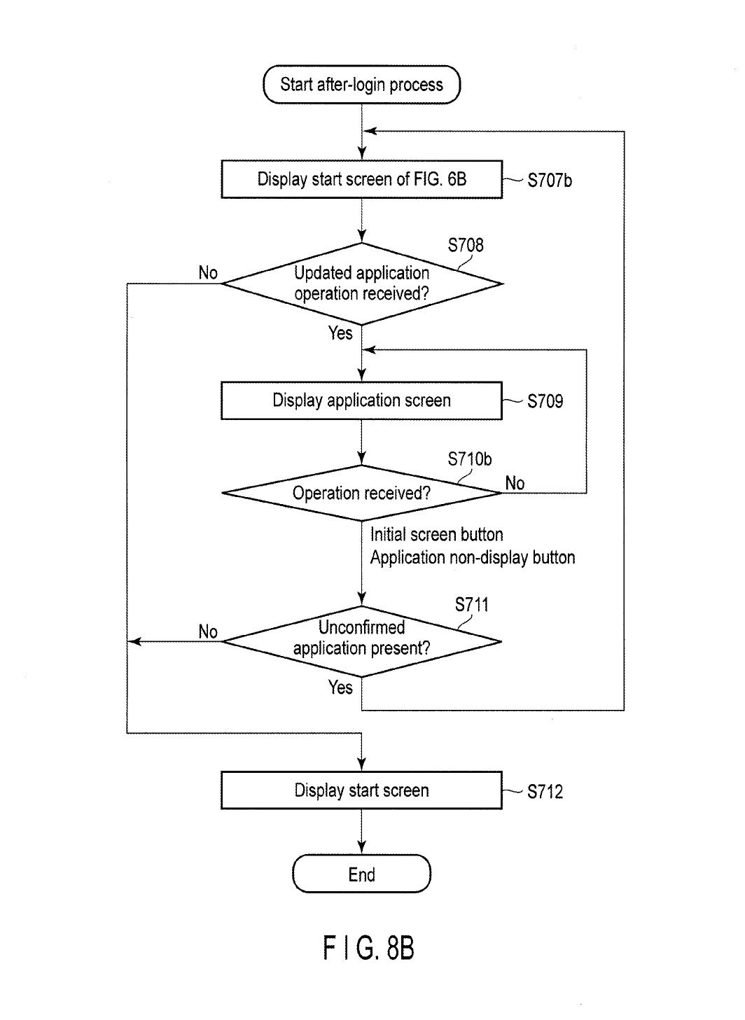

FIGS. 8A and 8B illustrate examples of process flow of the screen control by the PC 100. FIG. 8A illustrates an example of the process flow in a case where the update controller 304 displays a screen as shown in FIG. 6A as the update notification screen.

First, while the PC 100 is in the Connected Standby condition (standby mode) (S701), the update controller 304 inquires whether there is any update in each application status by polling each of the various applications 350. Then, if there is an update of the application status of any one of the various applications 350 (Yes of S702), the update controller 304 determines where an icon corresponding to the updated application is arranged on the update notification screen (S703).

If there are a plurality of updated applications, the update controller 304 determines the positions of the icons of the updated applications based on the priority order and latest update time of each application as mentioned above. The update controller 304 repeats polling while the PC 100 is in the standby mode and determines the position of the icon in each time of application status update.

Then, when the PC 100 receives an operation to reactivate the PC 100 (Yes in S704), the display 105 displays a lock screen shown in FIG. 5A (S705). The operation to reactivate the PC 100 is, for example, an operation to a mechanical button such as a power button of the PC 100 and the like. When the touch sensor 109 receives a lock release operation to the lock screen, the display 105 then displays a login screen shown in FIGS. 5B and 5C (S706).

When the login screen is displayed and a valid authentication code is input, the display 105 displays the update notification screen shown in FIG. 6A (S707). Here, when the touch sensor 109 receives an operation input to the update notification icon (Yes in S708), the application corresponding to the icon generates a screen of the application and then displays the screen on the display 105 (S709).

When the touch sensor 109 receives an operation input to set the application non-display/inactive or an operation input to terminate the application while the screen of the application is displayed (“Application non-display operation” in S710), the update controller 304 determines whether an icon which has not been selected by a user is in the update notification icon in the update notification screen (S711). In other words, the update controller 304 determines whether there is an application whose update has not been confirmed by the user. The operation to set the application non-display is, for example, a swipe operation from the periphery of the upper end of the display screen to the lower end thereof, or an operation on a return button.

If there is an application whose update has not been confirmed (Yes in S711), the update controller 304 again displays the update notification screen (S707). The update controller 304 displays the update notification screen from which the icon corresponding to the application whose update has already been confirmed is excluded.

On the other hand, when an operation input to an initial screen button for displaying a predetermined screen is received in S710 (“Initial screen button” in S710), or when there is no update unconfirmed application in S711 (No in S711), the display 105 displays the start screen shown in FIG. 7A (S713). The initial screen button is, for example, a mechanical button on a keyboard or display body, or a software button displayed on a screen. Furthermore, when the touch sensor 109 receives a screen transition operation without receiving an operation input to the update notification icon in S708 (No in S708), the display 105 displays a start screen (S712). The screen transition operation is, for example, an operation to the button P516 shown in FIG. 6A or an operation to the initial screen button. Furthermore, when the update controller 304 is operated as a single resident application independent from the launcher controller 303, the operation to set the resident application non-display may be works as the screen transition operation. Here, when the update controller 304 is operated as such a single resident application and the operation to the icon P631 on the start screen P630 is received (Yes in S713), the PC 100 again displays the update notification screen (S707).

FIG. 8B illustrates an example of a process flow in a case where the update controller 304 displays FIG. 6B as the update notification screen. In the flow of FIG. 8B, S701 to S706 in FIG. 8A are carried out similarly, and thus, explanation thereof is omitted. The process with the same reference numeral is the same process as that of FIG. 8A and thus, explanation is partly omitted.

The PC 100 displays a screen including the update notification screen within the start screen shown in FIG. 6B when the login process succeeds (S707b). Here, when an operation is performed on the update notification icon, the screen of the application corresponding to the icon is displayed (S709). Then, when the operation input to the initial screen button or operation input to set the application non-display is received (S710b), and there is an application whose update has not been confirmed (Yes in S711), the update controller 304 again displays the update notification screen shown in FIG. 6B (S707b). That is, since the update notification screen is structured as a part of the start screen in the flow of FIG. 8B, the update notification screen is displayed upon receipt of the operation to the initial screen button to instruct a transition from any screen to the start screen. However, when all of the application updates are confirmed (No in S711), no icon should be displayed in the update notification screen and thus, the display 105 displays the default start screen shown in FIG. 7A (S712).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus configured to output a screen on a display, the apparatus comprising:
a first display controller configured to output a first screen comprising an icon to be selected based on whether a program corresponding to the icon is updated, the first display controller being configured to output the first screen when the information processing apparatus is reactivated from a standby mode, the first screen comprising first and second icons which correspond to first and second programs and comprise images related to the update; and
a second display controller configured to output a second screen comprising the first icon and changeable from the first screen and to output a third screen comprising the second icon and changeable from the second screen, and
the first icon in the first screen and the first icon in the second screen indicative of an identical update, and the second icon in the first screen and the second icon in the third screen indicative of an identical update.

2. The information processing apparatus of claim 1, wherein the first program is configured to generate the image in the first icon, and the second program is configured to generate the image in the second icon.

3. The information processing apparatus of claim 2, further comprising a third program configured to acquire update information of the update of the first and second programs from the first and second programs and to arrange the first and second icons on the first screen based on the update information.

4. The information processing apparatus of claim 1, wherein the first icon in the first screen and the first icon in the second screen comprise an identical image, and the second icon in the first screen and the second icon in the third screen comprise an identical image.

5. The information processing apparatus of claim 4, further comprising a selector configured to select an icon displayed in the first screen in response to an operation input to the first screen, wherein
if the first icon is not selected by the selector, the first icon in the first screen and the first icon in the second screen comprise an identical image, and if the first icon is selected by the selector, the first icon in the first screen before the selection and the first icon in the second screen comprise different images.

6. The information processing apparatus of claim 1, further comprising:
a selector configured to select an icon displayed in the first screen in response to an operation input to the first screen;
an operation input module configured to receive an input of transition operation to instruct a transition from an optional screen to a predetermined screen; and
a third display controller configured to, when the transition operation is input, change to either the first screen or the second screen based on whether the first and second icons have been selected by the selector.

7. A non-transitory computer-readable storage medium having stored thereon a screen control program which is executable by a computer, the screen control program comprising instructions capable of causing the computer to execute functions of:
outputting a first screen when the computer is reactivated from a standby mode, the first screen comprising an icon to be selected based on whether a program corresponding to the icon is updated;
outputting the first screen comprising first and second icons which correspond to first and second programs and comprise images related to the update at the output of the first screen;
outputting a second screen comprising the first icon and changeable from the first screen; and
outputting a third screen comprising the second icon and changeable from the second screen, and
the first icon in the first screen and the first icon in the second screen indicative of an identical update, and the second icon in the first screen and the second icon in the third screen indicative of an identical update.

8. A screen control method in the information processing apparatus configured to output a screen in a display, the method comprising:
outputting a first screen when the information processing apparatus is reactivated from a standby mode, the first screen comprising an icon to be selected based on whether a program corresponding to the icon is updated;
outputting the first screen comprising first and second icons which correspond to first and second programs and comprise images related to the update at the output of the first screen;
outputting a second screen comprising the first icon and changeable from the first screen; and
outputting a third screen comprising the second icon and changeable from the second screen, and
the first icon in the first screen and the first icon in the second screen indicative of an identical update, and the second icon in the first screen and the second icon in the third screen indicative of an identical update.
